(19) United States
(12) Patent Application Publication
(10) Pub. No.: US 2013/0158734 A1
(43) Pub. Date: Jun. 20, 2013

(54) Apparatus And Method To Protect Distribution Networks Against Overcurrents Caused By Faults In Residential Circuits

(71) Applicant: Hyoung Jhang, Atlanta, GA (US)

(72) Inventor: Hyoung Jhang, Atlanta, GA (US)

(73) Assignee: General Electric Company, Schenectady, NY (US)

(21) Appl. No.: 13/328,742

(22) Filed: Dec. 16, 2011

(51) Int. Cl. G06F 1/28

(52) U.S. Cl. 700/293; 700/292

(57) ABSTRACT

Disclosed herein are methods, apparatuses, and systems for protection of distribution networks against overcurrents caused by faults in residential circuits. In an embodiment, a smart meter monitors a circuit for a particular condition and may adjust the power to a circuit when the condition is detected. In an embodiment, when an overcurrent condition is detected in a residential circuit, the residential circuit may be disconnected by a smart meter from a distribution network before it is seen by a recloser and therefore may isolate an outage to a single home.

### TECHNICAL FIELD

The technical field generally relates to distribution networks and more specifically relates to fault isolation of circuits.

### BACKGROUND

When a fault occurs on a distribution network, a recloser reacts against it immediately and works together with sectionalizers to restore the distribution network. If the fault persists, only a section involving the fault is isolated. Faults from residential circuits are treated identically by a recloser leaving multiple homes in outage.

### BRIEF DESCRIPTION OF THE INVENTION

Disclosed herein are methods, apparatuses, and systems for protection of distribution networks against overcurrents caused by faults in residential circuits. In an embodiment, a smart meter monitors a circuit for a particular condition and may shutdown the circuit when the condition is detected. In an embodiment, when an overcurrent condition is detected in a residential circuit, the residential circuit may be disconnected immediately by a smart meter from a distribution network before it is seen by a recloser and therefore may isolate an outage to a single home.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

A more detailed understanding may be had from the following description, given by way of example in conjunction with the accompanying drawings wherein:

FIG. 1 is a graphical representation of an exemplary, non-limiting network in which protection of distribution networks against overcurrents caused by faults in residential circuits may be implemented;

FIG. 2 is an exemplary illustration of a house with a smart meter attached;

FIG. 3 is a graphical representation of an exemplary, non-limiting network in which protection of distribution networks against overcurrents caused by faults in residential circuits may be implemented;

FIG. 4 illustrates a non-limiting, exemplary method of implementing protection of distribution networks against overcurrents caused by faults in residential circuits; and

FIG. 5 is an exemplary block diagram representing a general purpose computer system in which aspects of the present invention thereof may be incorporated.

### DETAILED DESCRIPTION OF THE INVENTION

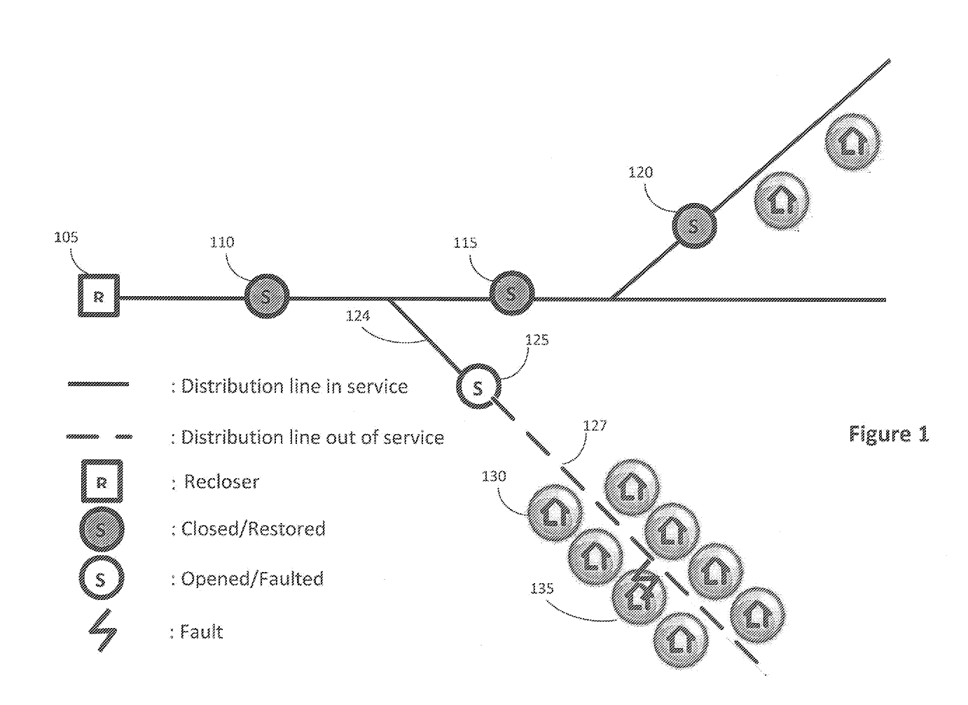

FIG. 1 is a graphical representation of an exemplary, non-limiting network in which protection of distribution networks against overcurrents caused by faults in residential circuits may be implemented. There is a recloser at 105. Recloser 105 may be a circuit breaker that is capable of resetting itself after having tripped or opened due to a line fault and may be used on main grid supply lines. Recloser 105 may be designed to automate the resumption of electrical supplies where line faults are transient by nature. Faults may include lightning strikes and bird or animal activity and may normally require manual intervention to reset, thereby leaving consumers without power for protracted periods. Recloser 105 may be operable to sense the magnitude of current flowing through a main supply line and disable the entire downstream distribution system if currents above a certain magnitude are detected. After a short period of current interruption, recloser 105 may automatically re-energize the circuit unless excess current conditions are again subsequently sensed.

In FIG. 1, there are sectionalizers at 110, 115, 120, and 125. As shown here, the sectionalizers may be installed at the beginning of each lateral line of a power distribution system that has a recloser. Each sectionalizer may cooperate with recloser 105 by disabling the respective lateral line served by the sectionalizer during a subsequent dead portion of one of the opening and closing cycles of recloser 105, if current conditions in the lateral line are greater than a certain, pre-selected value. In this manner, current flow may be automatically restored to the remaining lateral lines during a subsequent closing cycle of recloser 105. Here, sectionalizers 110, 115, and 120 are closed. Sectionalizer 125 may be in a faulted state because the distribution line 127 faulted due to a condition within house 135. All the homes connected to line 135 may be isolated and therefore may not receive power. If such faults are detected and isolated before they are seen by recloser 105, an outage may be minimized to a single home.

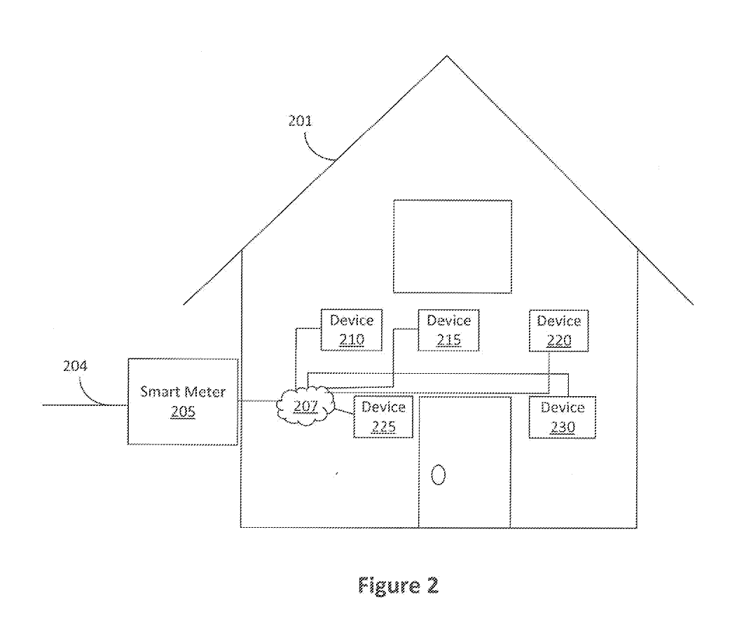

FIG. 2 is an exemplary illustration of a house 201 with a smart meter 205 attached and several electrical devices associated with the house 201. Electrical devices 210, 215, 220, 225, and 230 may be connected at junction 207 and junction 207 may connect to smart meter 205. In an embodiment all or some of the electrical devices may be directly connected to smart meter 205. Electrical power may run through power line 204 and connect through smart meter 205 and junction 207 before being distributed to the electrical devices 210, 215, 220, 225, and 230. Smart meter 205 may be capable of two-way communication to a main communications center server, for example. Smart meter 205 may be configured to monitor current and other power attributes periodically or continuously and save the monitoring data to a local or remote database. Examples of other power attributes may be active power, reactive power, voltage, phase, or frequency. In an embodiment, smart meter 205 may monitor active and reactive parts of energy.

Smart meter 205 may also be configured with a trigger which when reached reduces power or closes the circuit (cuts off power) to house 201. The trigger may be statically configured based on values selected by an operator. The trigger may also be dynamically configured based on analysis of historical data from house 205 or from houses similarly situated to house 205. The trigger may be based on load signature or pattern, usage pattern, timing, threshold, and rate of change of selected power attributes. Smart meter 205 and associated network devices (e.g., servers and databases in communication with smart meter 205) may be able to react to and/or anticipate undesired electrical events because of constant monitoring and analysis of normal monitoring conditions.

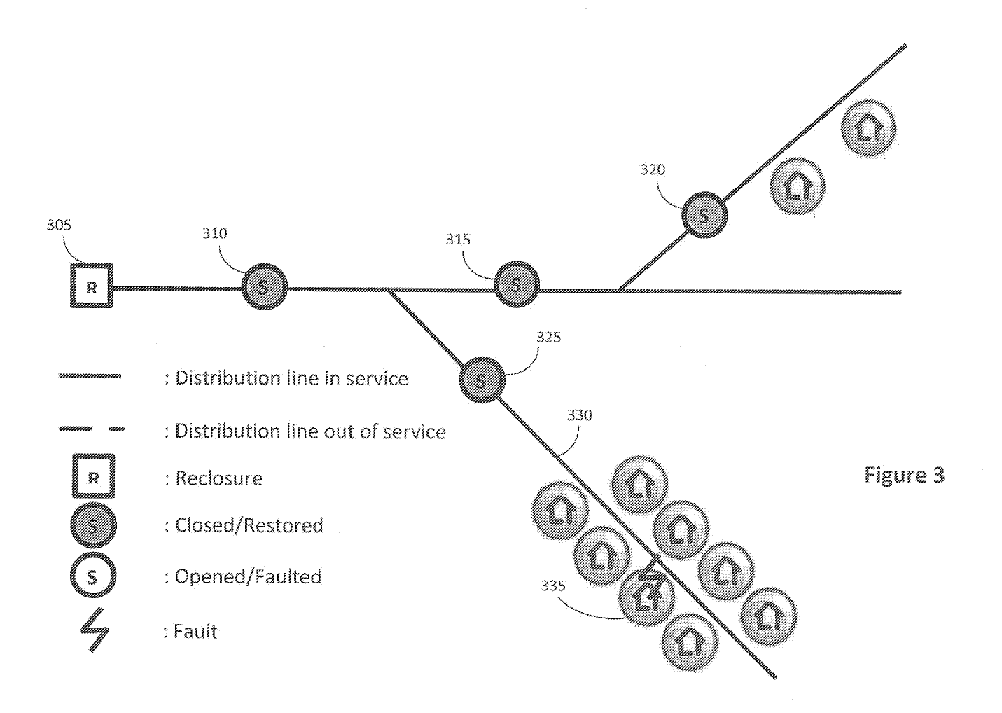

FIG. 3 is a graphical representation of an exemplary, non-limiting network in which protection of distribution networks against overcurrents caused by faults in residential circuits may be implemented. At 305 there may be a recloser. There may be sectionalizers at 310, 315, 320, and 325 at different points on a power distribution line. Distribution line 330 located downstream from sectionalizer 325 may be in a closed state and may have a house 335 in which there is a fault condition within house 335. Unlike FIG. 1, here in FIG. 3, the power interruption may be isolated to house 335.

FIG. 3 demonstrates the isolation of a residential circuit causing a fault. In an embodiment, a smart meter (not shown) connected to house 335 may be equipped with a load control relay. The load control relay may be used to protect the distribution network against faults from residential circuits. The smart meter may monitor an overcurrent condition by measuring current flowing into the residential circuit at house 335 and comparing against a preset value. For example, if a current is higher than the preset value, it may raise an alert and disconnect the residential circuit from the distribution network by disconnecting the load control switch. If the meter is advanced metering infrastructure (AMI) enabled, this may be reported immediately to a remote server or other computing device. In an embodiment, the smart meter of house 335 may monitor and respond to current increases beyond a threshold voltage (e.g., 60 Amp). In another embodiment, the smart meter of house 335 may monitor and respond to reactive power increase or rate of change. In another embodiment, the smart meter of house 335 may monitor and respond to a phase angle increase between voltage and current.

When the overcurrent condition is detected in a residential circuit at house 335, the residential circuit at house 335 may be disconnected from the distribution network before it is seen by recloser 305. If the outage is seen by recloser 305 it may lead to an outage involving multiple houses. This overcurrent protection is at the micro level of a single house. This scheme may be implemented in a smart meter equipped with a load control relay by configuring the smart meter to monitor current and control relay. In an embodiment, even if the outage is seen by recloser 305, the recloser 305 may act or may not act based on contextual data communicated from the smart meter at house 335.

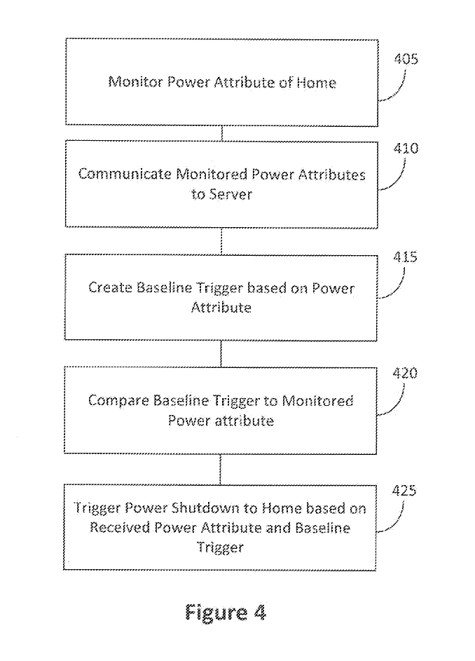

FIG. 4 illustrates a non-limiting, exemplary method of implementing protection of distribution networks against overcurrents caused by faults in residential circuits. At block 405 a smart meter connected to a home may monitor a power attribute (e.g., current) to and/or from the home. At block 410, the power attribute, in turn, may be communicated to a remote server or database. At block 415, a baseline trigger is created with regards to the shutdown of power to the house. In an embodiment, there initially may be a default baseline trigger and then a second or overriding baseline trigger after the appropriate amount of data is stored and analyzed. The data may be stored or analyzed locally or by a remote sever. The analysis may be based on a single residence or multiple residences (e.g., all homes in a particular county or city).

At block 420, the smart meter may compare the baseline trigger to a monitored power attribute. If the monitored power attribute matches the baseline trigger condition, at block 425 the smart meter may shutdown power to the home. In an embodiment, the smart meter may periodically restore power and check if the triggering condition still persists. The smart meter may also be configured to wait for a manual or remote command in order to restore power to the home. In an embodiment, reduction of power to the house or controlling individual devices power output (e.g., lowering or raising thermostat), such as devices that may cause overcurrent conditions, may be done instead of shutting down power.

Without in any way limiting the scope, interpretation, or application of the claims appearing herein, a technical effect of one or more of the example embodiments disclosed herein is to provide adjustments to the way undesired electrical conditions are isolated in a power network. Another technical effect of one or more of the embodiments disclosed herein is that undesirable electrical conditions at residence may be detected and responded to more quickly and efficiently such that a reduced number of residential homes are isolated.

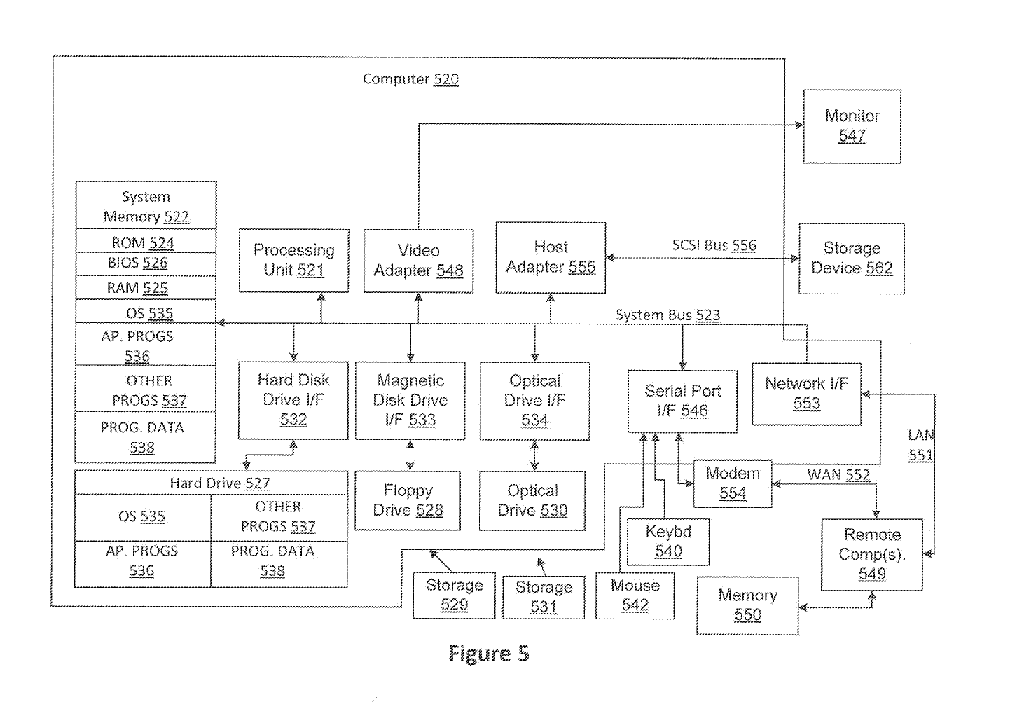

FIG. 5 and the following discussion are intended to provide a brief general description of a suitable computing environment in which the present invention and/or portions thereof may be implemented. Although not required, some aspects of the invention is described in the general context of computer-executable instructions, such as program modules, being executed by a computer, such as a client workstation, server, smart meter, or personal computer. Generally, program modules include routines, programs, objects, components, data structures and the like that perform particular tasks or implement particular abstract data types. Moreover, it should be appreciated that the invention and/or portions thereof may be practiced with other computer system configurations, including hand-held devices, multi-processor systems, microprocessor-based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

FIG. 5 is a block diagram representing a general purpose computer system in which aspects of the present invention and/or portions thereof may be incorporated. As shown, the exemplary general purpose computing system includes a computer 520 or the like, including a processing unit 521, a system memory 522, and a system bus 523 that couples various system components including the system memory to the processing unit 521. The system bus 523 may be any of several types of bus structures including a memory bus or memory controller, a peripheral bus, and a local bus using any of a variety of bus architectures. The system memory includes read-only memory (ROM) 524 and random access memory (RAM) 525. A basic input/output system 526 (BIOS), containing the basic routines that help to transfer information between elements within the computer 520, such as during start-up, is stored in ROM 524.

The computer 520 may further include a hard disk drive 527 for reading from and writing to a hard disk (not shown), a magnetic disk drive 528 for reading from or writing to a removable magnetic disk 529, and an optical disk drive 530 for reading from or writing to a removable optical disk 531 such as a CD-ROM or other optical media. The hard disk drive 527, magnetic disk drive 528, and optical disk drive 530 are connected to the system bus 523 by a hard disk drive interface 532, a magnetic disk drive interface 533, and an optical drive interface 534, respectively. The drives and their associated computer-readable media provide non-volatile storage of computer readable instructions, data structures, program modules and other data for the computer 520.

Although the exemplary environment described herein employs a hard disk, a removable magnetic disk 529, and a removable optical disk 531, it should be appreciated that other types of computer readable media which can store data that is accessible by a computer may also be used in the exemplary operating environment. Such other types of media include, but are not limited to, a magnetic cassette, a flash memory card, a digital video or versatile disk, a Bernoulli cartridge, a random access memory (RAM), a read-only memory (ROM), and the like.

A number of program modules may be stored on the hard disk, magnetic disk 529, optical disk 531, ROM 524 or RAM 525, including an operating system 535, one or more application programs 536, other program modules 537 and program data 538. A user may enter commands and information into the computer 520 through input devices such as a keyboard 540 and pointing device 542. Other input devices (not shown) may include a microphone, joystick, game pad, satellite disk, scanner, or the like. These and other input devices are often connected to the processing unit 521 through a serial port interface 546 that is coupled to the system bus, but may be connected by other interfaces, such as a parallel port, game port, or universal serial bus (USB). A monitor 547 or other type of display device is also connected to the system bus 523 via an interface, such as a video adapter 548. In addition to the monitor 547, a computer may include other peripheral output devices (not shown), such as speakers and printers. The exemplary system of FIG. 5 also includes a host adapter 555, a Small Computer System Interface (SCSI) bus 556, and an external storage device 562 connected to the SCSI bus 556.

The computer 520 may operate in a networked environment using logical connections to one or more remote computers, such as a remote computer 549. The remote computer 549 may be a personal computer, a server, a router, a network PC, a peer device or other common network node, and may include many or all of the elements described above relative to the computer 520, although only a memory storage device 550 has been illustrated in FIG. 5. The logical connections depicted in FIG. 5 include a local area network (LAN) 551 and a wide area network (WAN) 552. Such networking environments are commonplace in offices, enterprise-wide computer networks, intranets, and the Internet.

When used in a LAN networking environment, the computer 520 is connected to the LAN 551 through a network interface or adapter 553. When used in a WAN networking environment, the computer 520 may include a modem 554 or other means for establishing communications over the wide area network 552, such as the Internet. The modem 554, which may be internal or external, is connected to the system bus 523 via the serial port interface 546. In a networked environment, program modules depicted relative to the computer 520, or portions thereof, may be stored in the remote memory storage device. It will be appreciated that the network connections shown are exemplary and other means of establishing a communications link between the computers may be used.

Computer 520 may include a variety of computer readable storage media. Computer readable storage media can be any available media that can be accessed by computer 520 and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 520. Combinations of any of the above should also be included within the scope of computer readable media that may be used to store source code for implementing the methods and systems described herein. Any combination of the features or elements disclosed herein may be used in one or more embodiments.

In describing preferred embodiments of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed:

1. A method comprising:
receiving a power attribute from a circuit to a building;
comparing a baseline condition to the monitored power attribute;
detecting that the baseline condition is met; and
adjusting power to the circuit entering into the building, based on the met baseline condition.

2. The method of claim 1, the building includes a residence.

3. The method of claim 1, the power attribute comprising at least one of a current, an active power, a reactive power, a voltage, a phase, or a frequency.

4. The method of claim 1, the adjustment of power to the circuit of the building comprising shutting off power to the circuit.

5. The method of claim 1, the baseline condition is based on at least one of a load signature or pattern, usage pattern, timing, threshold, or rate of change of the power attribute.

6. The method of claim 1, the baseline condition is dynamically changed based on analysis of the monitored power attribute over a time period.

7. The method of claim 1, wherein the baseline condition is reported to a recloser from a smart meter.

8. A smart meter configured to:
receive a power attribute from a circuit to a building;
compare a baseline condition to the monitored power attribute;
detect that the baseline condition is met; and
adjust power to the circuit entering into the building, based on the met baseline condition.

9. The smart meter of claim 8, the building includes a residence.

10. The smart meter of claim 8, the power attribute comprises at least one of a current, an active power, a reactive power, a voltage, a phase, or a frequency.

11. The smart meter of claim 8, the adjustment of power to the circuit of the building comprising shutting off power to the circuit of the building.

12. The smart meter of claim 8, the adjustment of power to the circuit of the building comprising adjusting power to a device in the building.

13. The smart meter of claim 8, the baseline condition is dynamically changed based on analysis of the monitored power attribute over a time period.

14. A system comprising:
a smart meter configured to:
receive a power attribute from a circuit to a building;
compare a baseline condition to the monitored power attribute;
detect that the baseline condition is met; and
adjust power to the circuit entering into the building, based on the met baseline condition; and
a server configured to receive data from the smart meter.

15. The system of claim 14, the baseline condition is dynamically changed based on analysis of the monitored power attribute over a time period.

16. The system of claim 14, wherein the server is configured to:
analyze power attribute data from a region; and
transmit an updated baseline condition to the smart meter based on the analyzed power attribute data from the region.

17. The system of claim 14, the power attribute comprising at least one of a current, an active power, a reactive power, a voltage, a phase, or a frequency.

18. The system of claim 14, the baseline condition based on at least one of a load signature or pattern, usage pattern, timing, threshold, or rate of change of the power attribute.

19. The system of claim 14, further comprising a recloser configured to communicate with the smart meter.

20. The system of claim 14, the adjustment of power to the circuit of the building comprising adjusting power to a device in the building.
